(19) United States
(12) Patent Application Publication
(10) Pub. No.: US 2022/0092170 A1
(43) Pub. Date: Mar. 24, 2022

(54) MALICIOUS FILES DETECTION AND DISARMING

(71) Applicant: YAZAMTECH LTD., Ra'anana (IL)

(72) Inventors: Yosi SHANI, Ra'anana (IL); Alex DEMIDOV, Yitzhar (IL)

(21) Appl. No.: 17/026,634

(22) Filed: Sep. 21, 2020

(51) Int. Cl. G06F 21/54; G06F 21/56

(52) U.S. Cl. CPC G06F 21/54; G06F 2221/033; G06F 21/568

(57) ABSTRACT

A method comprising: detecting a start of one of a set of monitored process, each associated with an application installed on a computer system, injecting said detected monitored process of said set of monitored process with a software module configured to intercept specified functions calls by the monitored process, wherein said specified function call are associated with file operations attempted by the monitored process, intercepting, by said software module, a function call of one of said specified function calls, modifying, by said software module, an execution of said function, to suspend said file operation attempted by said monitored process, processing a file referenced by said file operation, by applying a plurality of data security operations thereupon, returning an expected value to said monitored process with respect to said file, and issuing a notification to a user of said computer system with respect to a result of said processing.

### FIELD OF THE INVENTION

The invention relates to the field of computer security.

### BACKGROUND OF THE INVENTION

Content disarm and reconstruction (CDR) or data sanitization attempts to protect a computer operating system from receiving infected files, emails or malware, by removing disallowed file components and content, within an allowed file type definition or which file components are otherwise forbidden by security policies.

CDR typically consists of a software application that recognizes file formats, strips unrecognized or disallowed formats (the disarm function), and either only permits completely allowed files in their entirety to continue to the addressee computer, or reconstructs the file by limiting the transmitted file to only those file components that are recognized and allowed (the reconstruction function).

The foregoing examples of the related art and limitations related therewith are intended to be illustrative and not exclusive. Other limitations of the related art will become apparent to those of skill in the art upon a reading of the specification and a study of the figures.

### SUMMARY OF THE INVENTION

The following embodiments and aspects thereof are described and illustrated in conjunction with systems, tools and methods which are meant to be exemplary and illustrative, not limiting in scope.

There is provided, in an embodiment, a system comprising at least one hardware processor; and a non-transitory computer-readable storage medium having stored thereon program instructions, the program instructions executable by the at least one hardware processor to: detect a start of one of a set of monitored process, each associated with an application installed on a computer system, inject said detected monitored process of said set of monitored process with a software module configured to intercept specified functions calls by the monitored process, wherein said specified function call are associated with file operations attempted by the monitored process, intercept, by said software module, a function call of one of said specified function calls, modify, by said software module, an execution of said function, to suspend said file operation attempted by said monitored process, process a file referenced by said file operation, by applying a plurality of data security operations thereupon, return an expected value to said monitored process with respect to said file, and issue a notification to a user of said computer system with respect to a result of said processing.

There is also provided, in an embodiment, a method comprising: detecting a start of one of a set of monitored process, each associated with an application installed on a computer system, injecting said detected monitored process of said set of monitored process with a software module configured to intercept specified functions calls by the monitored process, wherein said specified function call are associated with file operations attempted by the monitored process, intercepting, by said software module, a function call of one of said specified function calls, modifying, by said software module, an execution of said function, to suspend said file operation attempted by said monitored process, processing a file referenced by said file operation, by applying a plurality of data security operations thereupon, returning an expected value to said monitored process with respect to said file, and issuing a notification to a user of said computer system with respect to a result of said processing.

There is further provided, in an embodiment, a computer program product comprising a non-transitory computer-readable storage medium having program instructions embodied therewith, the program instructions executable by at least one hardware processor to: detect a start of one of a set of monitored process, each associated with an application installed on a computer system, inject said detected monitored process of said set of monitored process with a software module configured to intercept specified functions calls by the monitored process, wherein said specified function call are associated with file operations attempted by the monitored process, intercept, by said software module, a function call of one of said specified function calls, modify, by said software module, an execution of said function, to suspend said file operation attempted by said monitored process, process a file referenced by said file operation, by applying a plurality of data security operations thereupon, return an expected value to said monitored process with respect to said file, and issue a notification to a user of said computer system with respect to a result of said processing.

In some embodiments, the set of monitored processes is predetermined by a user of said computer system with respect to each of said applications.

In some embodiments, the software nodule comprises a dynamic-link library (DLL) hook configured to perform said intercepting.

In some embodiments, the specified function call is a close for a handle.

In some embodiments, the computer system comprises a Windows operating system, and said specified function call NtClose.

In some embodiments, the file operations are one of: write, append, modify, upload, and delete.

In some embodiments, the processing only occurs when said file meets a plurality of criteria selected form the group consisting of: not a system file; not a hidden file; not a read-only file; has a length of more than 1 byte; does not exist in a delete queue; and has a single reference upon itself.

In some embodiments, the processing only occurs when said file is located in a folder that is not one of: a temporary folder, and a Program Data folder.

In some embodiments, the plurality of security operations are selected form the group consisting of: file approval, file blocking, file quarantining, and record of file operations.

In addition to the exemplary aspects and embodiments described above, further aspects and embodiments will become apparent by reference to the figures and by study of the following detailed description.

### BRIEF DESCRIPTION OF THE DRAWINGS

Exemplary embodiments are illustrated in referenced figures. Dimensions of components and features shown in the figures are generally chosen for convenience and clarity of presentation and are not necessarily shown to scale. The figures are listed below.

FIG. 1 illustrates an exemplary system for disarming and sanitizing malicious content from entering or affecting a computer system via received electronic content, in accordance with some embodiments of the present invention;

FIG. 2 is a block diagram of an exemplary network computing environment, in accordance with some embodiments of the present invention;

FIG. 3 is a flowchart detailing the functional steps in a process for disarming and sanitizing malicious content from entering or affecting a computer system via received electronic content, in accordance with some embodiments of the present invention;

FIGS. 4A-4C show exemplary user interface screens of an exemplary system for disarming and sanitizing malicious content from entering or affecting a computer system via received electronic content, in accordance with some embodiments of the present invention; and

FIG. 5 schematically illustrates a security process with respect to received content, in accordance with some embodiments of the present invention.

### DETAILED DESCRIPTION OF THE INVENTION

Described herein are a system, method, and computer program product for disarming, sanitizing, ‘whitelisting’, ‘blacklisting’, laundering and/or otherwise preventing the creation of malicious content within a computer system via file operations, e.g., downloading, creation, modification, uploading, and/or deletion of a file within the computer system.

File operations (e.g., creation and/or modification) by any application running on a computer system or any other medium (e.g., email body and attachments, web browsing download, file system, removable media), may introduce content or files into the computer system or network, which may be infected with a wide range of threats, e.g., advanced persistent threats, trojans, and ransomware. These constantly-updated attack vectors can easily bypass typical enterprise security systems, such as anti-virus, EDR/EPP, anti-spam, mail relay, firewalls, sandbox, etc. Thus, large amounts of sensitive information may be deleted, encrypted or changed by content received from and/or created by malicious senders.

In one example, unauthorized content may be introduced into a computer system or environment (e.g., enterprise network) via file downloads (e.g., media content) from communications applications such as WhatsApp, Zoom, or peer-to-peer applications, such as Telegram, and the like. These communications applications may be installed on the computer system, e.g., a user device, or may be browsing applications). The downloaded and/or created content can be opened in the background or by a user before any anti-virus/EDR/EPP protection can complete a scan and block of the content, and thus any malicious content included therein may be executed on the user device before malicious content may be detected and handled, e.g, removed from these files.

Accordingly, in some embodiments, the present disclosure provides for automated real-time detection of running processes which attempt to perform file operations involving, e.g., importing, downloading, saving, deleting, and/or modifying any content to a computer system, whether user-initiated and/or authorized or not. The present disclosure then provides for interceding in the file operation saving process (as noted, e.g., importing, downloading, saving, deleting, and/or modifying, to scan and determine a security status of the content and appropriate treatment thereof, before allowing the process to proceed and making the content available for use in the computer system.

In some embodiments, the present disclosure continuously monitors running processes associated on a computer system, to identify and detect processes associated with the specified applications. In some embodiments, the specified applications may be, e.g., user-selected application which may pose, or are determined to be associated with, a risk of introducing unauthorized content into the computer system. In some embodiments, such unauthorized content may be introduced to the computer system as part of an attempted file operation, e.g., importing, downloading, saving, deleting, and/or modifying of any file (e.g., documents, media files, and/or any active content). In some embodiments, such content may be introduced in a variety of ways (e.g., by downloading a file or via save-as processes, background downloads, and/or drive-by downloads).

In some embodiments, the present disclosure is configured to inject an identified running process with a software module which hooks the running process, establishes communication with the service, loads application configuration, and intercepts certain application programming interfaces (API) indicating file operations, e.g., APIs associated with closing of a file handle.

In some embodiments, when a hooked API is invoked by the running process, which may provide an indication of a file save or another file-related operation being attempted by the running process, the injected software module intercepts the API invocation to capture the saved file system path used by the process.

The software module then closes the handle, assumes control over the file, and provides for CDR actions (scanning, analyzing, filtering, synthesizing) the file, to determine a security status and remove threats of the file and any appropriate treatment thereof, e.g., according to predetermined security policy and rules. Once file analysis and processing is completed, the software module returns control of the file to the hooked running process, such that the file content may become available to a user of the computer system.

By interjecting into and suspending the file save pereion process (e.g., importing, downloading, saving, deleting, and/or modifying, the present disclosure provides for scanning and disarming or sanitizing the unauthorized content before it becomes available for opening, use and/or execution on the computer system, or exported from the device. This process is performed in real time, on the fly, without interrupting or crashing any running processes, and with minimal latency. Thus, the risk that downloaded content will be inadvertently executed before scanning and whitelisting is prevented.

A potential advantage of the present disclosure is, therefore, in that it provides for the ability to scan and remedy new unauthorized content being introduced into the computer system, before the completion of the file operations, and before the content becomes available on the computer system. The present disclosure performs this task in a way that involves negligible interruption and latency from a user perspective, and avoids crashing any running processes on the computer system.

By way of background, malicious actors attempt to gain control of a computer system through the execution of malicious code or active content at the victim computer. Malicious code may be embedded in files (e.g., as part of importing, downloading, saving, deleting, and/or modifying), e.g., documents or media content files, such as an image, audio, or video files. Malicious active content may be embedded in documents that can configured to carry out an action or trigger an action, e.g., word processing and spreadsheet macros, formulas, scripts etc.

Malicious or suspicious content, as used herein, may refer to any malicious content, code, scripts, active content, embedded object (which may be hidden) or software designed or intended to damage, disable, or take control over a computer system, or device. Malicious code may include any of malware, computer viruses, worms, trojan horses, ransomware, spyware, shellcode, etc.

In the present disclosure, the terms ‘file,’ ‘input file,’ ‘received file,’ and ‘received content’ may be used interchangeably to denote any received content or file, including any form of electronic content, file, document, e-mail, etc., or other objects that may be run, processed, opened or executed by an application or operating system of a computer system or device.

Received content or file including any embedded or encoded malicious content, accessed by a computer system by, e.g., importing, downloading or otherwise receiving from an external source (e.g., webserver), from receiving as an e-mail or e-mail attachment, or any other means for accessing or receiving a file.

An input file may be a file received, requested, or accessed by a user or any processes or applications running on the computer system. In some embodiments, an input file may not necessarily be actively received or requested by a user of the computing system, and may be the result of an authorized or surreptitious background download process. For example, when a user attempts to print out a webpage, typically, this operation includes downloading a print file to the host computer, for printing. For example: local installed email servers and clients, such as the Microsoft Exchange email server and the Outlook email client, permanently collect incoming emails from the internet without the user involvement, which means that malicious email with its attachments are probably arrived to the device with any CDR involvement before it.

Received content or input file according to the present disclosure may include any file or file-like content, such as an embedded object or script, that is processed, run, opened or executed by an application or operating system of a computing system, or opened at the user initiative. The disclosed techniques are also applicable to objects within or embedded in an input file, without consideration as to whether they themselves may be considered to be files.

In some embodiments, received content or file according to the present disclosure includes malicious active content. Active content refers to any content embedded in a document that can be configured to carry out an action or trigger an action, such as word processing and spreadsheet macros, formulas, scripts, etc. An action can include any executable operation performed within or initiated by the rendering application. Active Content may include macros, JavaScript, OLE (object Linking & Embedding) objects, Flash, Encapsulated PostScript (EPS), and remote access URLs.

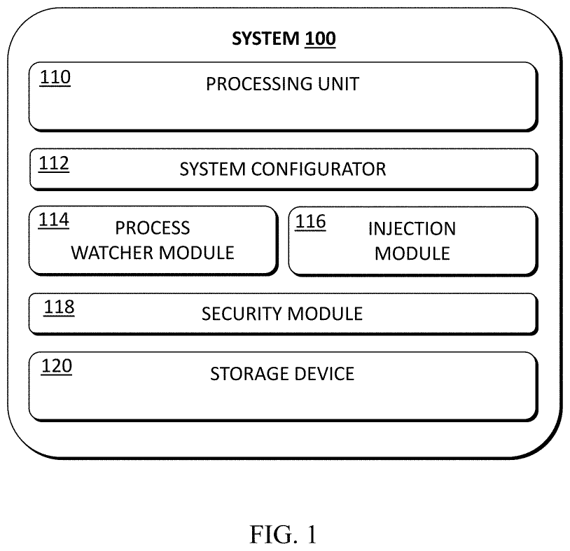

FIG. 1 illustrates an exemplary system 100 for disarming and sanitizing malicious content from entering or affecting a computer system via received electronic content, in accordance with some embodiments of the present invention.

In some embodiments, system 100 may comprise a processing unit 110 and memory storage device 120. In some embodiments, system 100 may store in a non-volatile memory thereof, such as storage device 120, software instructions or components configured to operate a processing unit (also “hardware processor,” “CPU,” or “processor”), such as processing unit 110. In some embodiments, the software components may include an operating system, including various software components and/or drivers for controlling and managing general system tasks (e.g., memory management, storage device control, power management, etc.) and facilitating communication between various hardware and software components.

In some embodiments, system may further include system configurator 112, process watcher module 114, injection module 116, and security module 118.

System 100 as described herein is only an exemplary embodiment of the present invention, and in practice may have more or fewer components than shown, may combine two or more of the components, or may have a different configuration or arrangement of the components. The various components of system 100 may be implemented in hardware, software, or a combination of both hardware and software. In various embodiments, system 100 may comprise a dedicated hardware device, or may form an addition to or extension of an existing device.

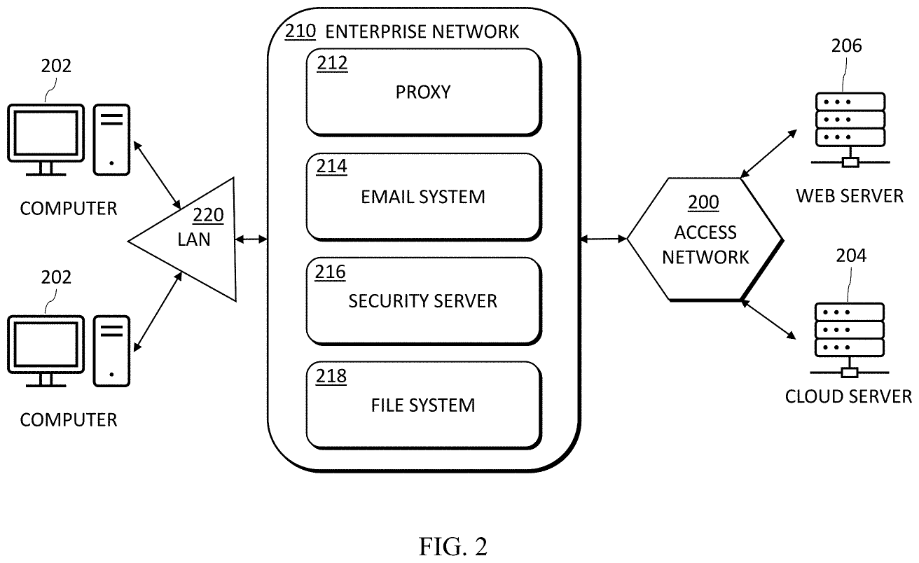

For example, the various components, modules, and functions of system 100 may be implemented or distributed among one or more interconnected computing devices in the exemplary computing environment depicted in FIG. 2, e.g., in hardware, software, or a combination of both hardware and software. Similarly, software instructions or components configured to operate system 100 may be implemented in one or more of the components of the computing environment depicted in FIG. 2.

FIG. 2 is a block diagram of an exemplary network computing environment, in accordance with some embodiments of the present invention. As shown, the environment may include a plurality of computing systems interconnected via one or more networks, e.g., access network 200, and enterprise network 210. Network 210 may include one or more computers 202 communicating with enterprise network 210 via, e.g., local area network (LAN) 220, proxy 212, email system 214, security server 216, and file system 218. Computers 202 and other computing devices of network 210 may be capable of communicating with one or more remote servers 204, 206.

Computers 202 may be any type of computing system, e.g., a desktop computer, laptop computer, tablet, smartphone, a server, printer, and any other networking components.

File system 218 may include one or more file servers, which may refer to any type of computing component or system for managing files and other data for network 210.

Security server 216 may be configured for performing CDR processes for analyzing, scanning, disarming, and/or sanitizing input content. In addition, security server 216 may be configured to perform one or more malware detection algorithms, such as a blacklist, whitelist or signature-based malware detection algorithm, or other known behavior-based algorithms or techniques for detecting malicious activity in a monitored run environment. Security server 216 may be in communication with any of the computing components of network 210, and may be configured to return, forward, or store a modified input file or modified input content.

Proxy 212 may be configured for handling communication requests between one or more interconnected computing devices of network 210 and/or between external networks and computing devices. Email system 214 may be configured to handle electronic mail communications between one or more interconnected computing devices of network 210, and other devices external to network 210.

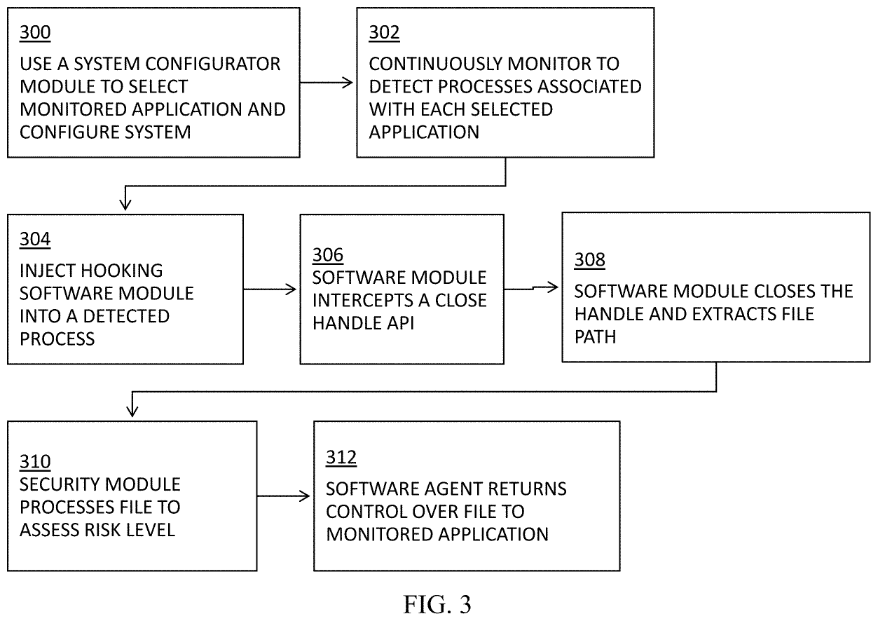

The processes implemented by the components and functions of exemplary system 100 in FIG. 1 and/or exemplary environment depicted in FIG. 2 will now be described with reference to the functional steps in the flowchart in FIG. 3.

FIG. 3 is a flowchart detailing the functional steps in a process for disarming and sanitizing malicious content from entering or affecting a computer system via received electronic content, in accordance with some embodiments of the present invention.

In some embodiments, at step 300, a system configurator module 112 of system 100, or an equivalent functionality, may be used to configure the present system.

In some embodiments, system configurator 112 provides for determining operational settings and parameters for system 100, e.g., by an administrator or a user of system 100. In some embodiments, system configurator 112 permits determining user settings with respect to one or more of:
Identity of application to be monitored by system 100,
security policy and rules applicable to each monitored application,
types of file operations to be monitored (e.g., ‘write,’ ‘read,’ ‘append,’ ‘delete’),
size of files to be processed, and/or
excluded folder locations.

Accordingly, in some embodiments, system configurator 112 may be used to identify one or more applications running on a computer system, e.g., computer 202 in FIG. 2, as monitored applications. Monitored applications may include, but are not limited to, the application detailed in Table 1 below:

TABLE 1
Exemplary monitored applications.

| | DESKTOP CLIENTS | | | | |
|---|---|---|---|---|---|
| | Desktop, | | | | |
| | Client | | | | |
| | applicaiton, | Desktop, | | | |
| | with a | Client | Desktop, | | OTHER |
| | remote | application, | Local | BROWS- | APPLI- |
| | server | peer to peer | applications | ERS | CATIONS |
| 1 | WhatsApp | Telegram | Word | Chrome | Wi-Fi |
| 2 | Signal | Instagram | Excel | Edge | Bluetooth |
| 3 | Skype | | PowerPoint | Internet | VPNs |
| | | | | Explorer | |
| 4 | Zoom | | Notepad | Firefox | Printing |
| 5 | Dropbox | | | Opera | |
| 6 | Outlook | | | | |
| 7 | WeChat | | | | |

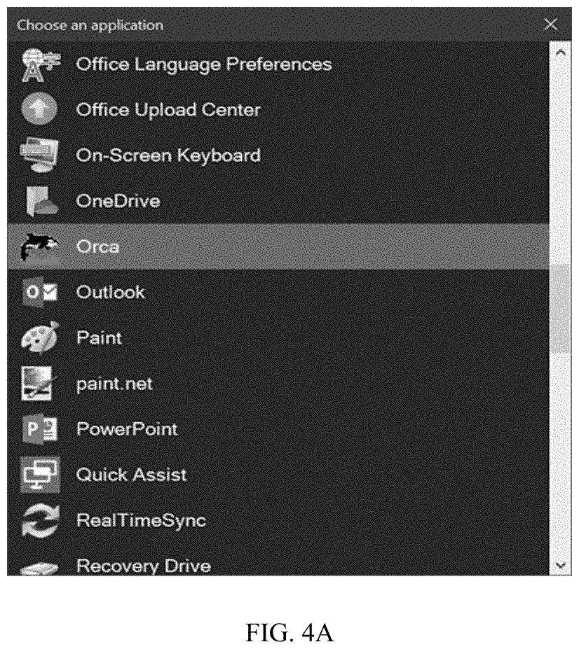

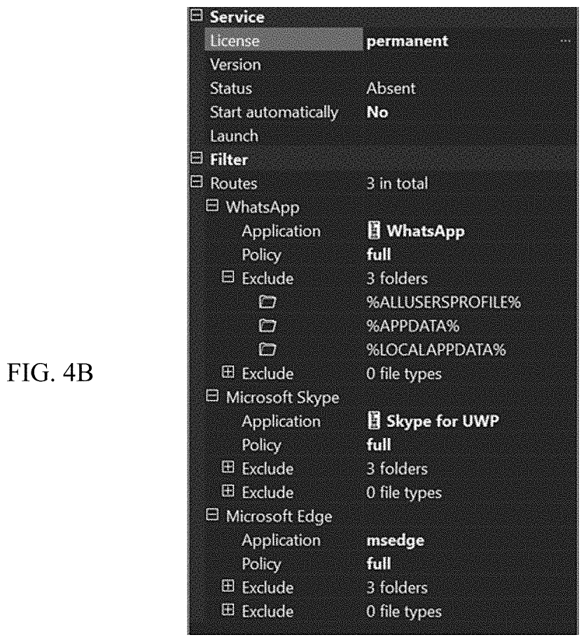

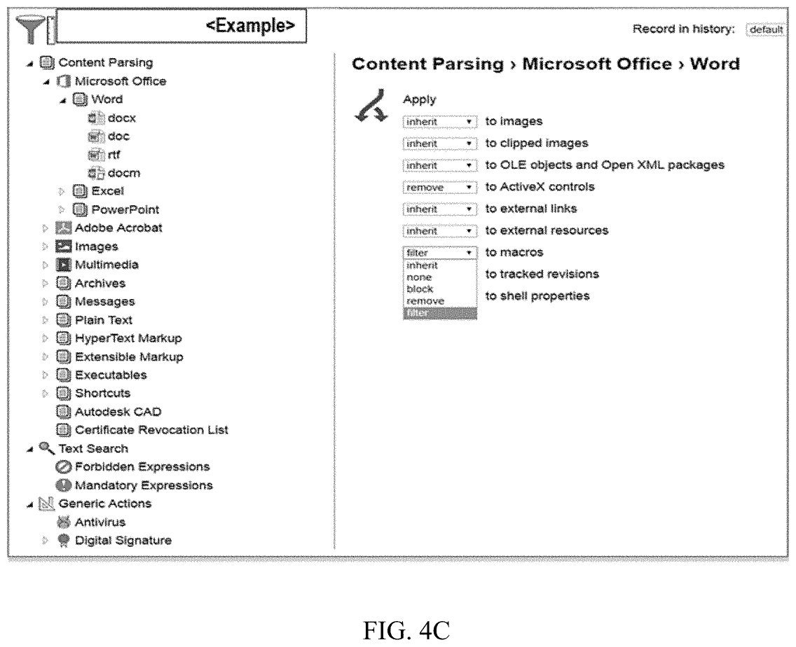

An exemplary user interface screen for selecting monitored applications is shown in FIG. 4A.

An exemplary user interface screen for determining operational settings of with respect to each selected application is shown in FIG. 4B.

In some embodiments, system configurator 112 may be used to set, with respect to each of the applications, a security policy applicable to each application, wherein the security policy comprises rules regarding approval, blocking, remediation, quarantine, or recording of file operations.

An exemplary user interface screen for determining policy and rules with respect to a monitored application (e.g. MS Word) is shown in FIG. 4C.

In some embodiments, system configurator 112 may be used set, with respect to each of the applications, file system locations, e.g., folders, which may be excepted from the security policy. For example, temporary file folders.

In some embodiments, at step 302, the present system 100 may be configured to continuously monitor one or more designated processes associated with one or more of the applications selected at step 300.

Accordingly, in some embodiments, process watcher module 114 of system 100, or an equivalent functionality, may be configured to continuously monitor for one or more designated processes associated with each of the selected applications. In some embodiments, process watcher module 114 may access a database of predetermined designated processes associated with each of the selected applications. In some embodiments, predetermined designated processes associated with each of the selected applications may be user-entered.

In some embodiments, process watcher module 114 may be configured to monitor which application is run on the computer system, e.g., computer 202 in FIG. 2, that is, which of the selected computer programs are processed by the computer device.

In some embodiments, monitoring active application may comprise monitoring a process using a combination of Windows Management Instrumentation (WMI) notifications (on classes Win32_ProcessStartTrace and Win32_ProcessStopTrace) and polling a list of running processes using Win32 API EnumProcesses. In this case, a list of returned processes may be filtered based on executable file location.

In some embodiments, monitoring of applications may comprise monitoring executable programs. An executable program is a compiled program that has been translated into computer code in a format that can be loaded into memory of the computer device and run by a processor of the computer device. When a user activates an executable program, the operating system manages the running of that program and the active application component has access to executable file information such as file name, file version, and file size and the program's start time and end time. This information may be accessed by way of the operating system or another program that controls processes on the computer device. For example, on a computer device running the Windows operating system, the information may be similar to that displayed by the Windows Task Manager component.

In other embodiments, additional and/or other methods may be implemented to detect designated one or more running processes in various computing environments and operating systems.

In some embodiments, at step 304, when one or more designated processes has been detected as running on the computer system, injection module 116 of system 100, or an equivalent functionality, may be configured to inject the process with a software module for hooking the running designated process.

As used herein, ‘hooking’ refers to a range of techniques used to alter or augment the behavior of a software component, e.g., an application or a running process thereof, by intercepting function calls, messages, or events invoked by the software component. Accordingly, code, such as an injected software module of the present disclosure, that handles such intercepted function calls, events or messages is called a hook. For example, an alternative implementation of API functions is hooked into the operating system by utilizing a replacement API table. The functions that have been replaced, augmented, or otherwise modified have entries in the table pointing to their new implementation. The entries for functions that have not been changed continue to point to existing implementations.

API hooking allows a component, such as a managed or unmanaged dynamically linked library (DLL) to provide an alternative implementation to an API function, without requiring existing applications to be recompiled. The alternative implementation can provide new functionality, and then delegate to the existing implementation to provide the remaining functionality, for example.

Accordingly, in some embodiments, the present method comprises injecting a software module into a running process, to hook and intercept specified API invocations by the process, and modify or manipulate these invocations. In some embodiments, the software module acts as an intercepting code configured to intercept specified API invocations by designated running processes.

In some embodiments, an injected software module of the present disclosure may be configured to hook and intercept a close handle API. For example, in a Windows operating system environment, the software module may be configured to hook the ntClose API. A close handle API indicate that a Windows handle is about to be closed by a monitored running process.

In some embodiments, at step 306, a software module of the present disclosure has intercepted a close handle API invoked by a designated running process.

In some embodiments, a software module of the present disclosure may be configured to intercept a close handle API based, at least in part, on a plurality of parameters associated with the file, such as, but not limited to, one or more of:
The handle is a file object,
its access includes “write,” “read,” “append,” or “delete” operations,
the file attributes do not include “system, “hidden,” “read-only,” or “temporary,”
the file was last modified after the monitored process had begun,
the file does not exist in a Windows delete queue,
the file size is more than 1 byte,
the file has a single reference upon itself, i.e., it is not opened more than once or duplicated,
is not in an NTFS alternate stream,
not an excluded file type of file location is not an excluded folder (e.g., temporary folders, Program Data folders).

In some embodiments, excluded file types may include, but are not limited to: ‘tmp’, ‘log’, ‘etl’, ‘ini’, ‘dat’, ‘dic’, ‘dll’, ‘manifest’, ‘application’, ‘srs’, ‘json’, ‘crdownload’, ‘pst’, ‘ost’, ‘nst’, ‘db’, ‘wal’, ‘shm’, ‘mdf’, ‘ndf’, ‘ldf’, ‘session’, and/or ‘sessionjournal’.

In some embodiments, at step 308, when the software module of the present disclosure has intercepted a close handle invocation involving a file or entity of interest based on the detailed parameters, the software module closes the handle, but does not return control of the file to the application. In some embodiments, before returning control to the application, the software module extracts and delivers a file system path to, e.g., security module 118 and/or security server 216, e.g., via .NET remoting.

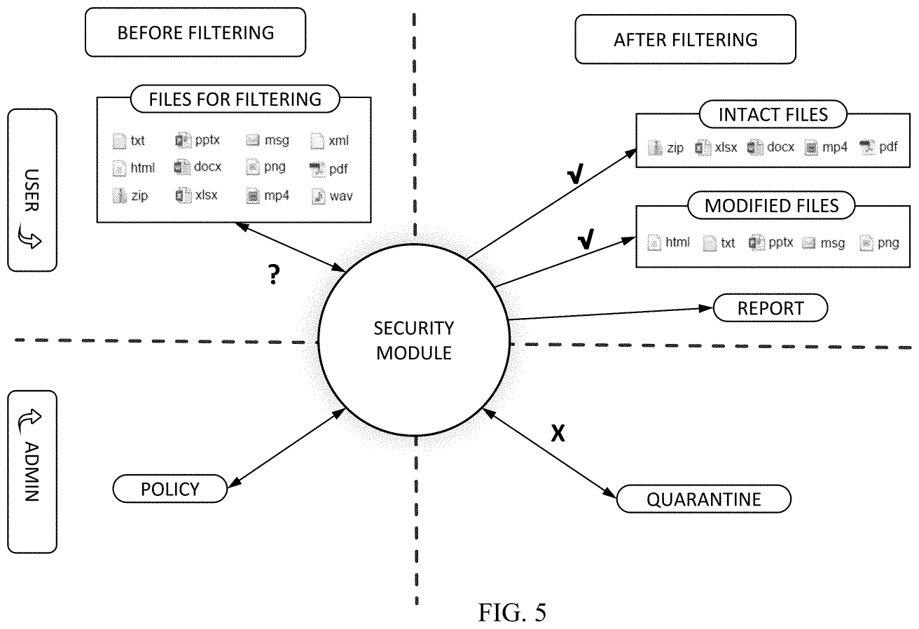

In some embodiments, at step 310, an intercepted file may be processed, e.g., by security module 118 and/or security server 216, as schematically illustrated in FIG. 5.

Security module 118 and/or security server 216 are configured to apply one or more operations relating to information security and in reference to predefined security policy and rule, such that the information is allowable for use within a computer system and/or enterprise network environment. Security module 118 and/or security server 216 may receive the information from any networked devices 210 in the network.

According to some embodiments of the invention, examples for operations relating to information security are: blocking of executable files, removing hostile code such as viruses, removing macros and scripts, removing hidden information, removing images according to specified criteria, cleaning FLASH files, removing file properties, allowing exporting of specified file types only, and/or removing or changing file metadata and/or hidden information.

In some embodiments, upon identifying suspicious or malicious content, the disclosed embodiments may render any malicious code that may be included in the input content inactive for its intended malicious purpose. In some embodiments it may be advantageous to quarantine or otherwise block or prevent an intended recipient from accessing any input content that has been determined to include suspicious or malicious code. In some embodiments, the present disclosure also implements tracking of received input content as it may be passed within an enterprise network to intended recipients.

In some embodiments, at step 312, upon completion of file processing by Security module 118 and/or security server 216, all relevant information is returned to the monitored process. In some embodiments, the monitored process may notify a user of the computer system using, e.g., a pop-up message (‘toast’).

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Rather, the computer readable storage medium is a non-transient (i.e., not-volatile) medium.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system comprising:
at least one hardware processor; and
a non-transitory computer-readable storage medium having stored thereon program instructions, the program instructions executable by the at least one hardware processor to:
detect a start of one of a set of monitored process, each associated with an application installed on a computer system,
inject said detected monitored process of said set of monitored process with a software module configured to intercept specified functions calls by the monitored process, wherein said specified function call are associated with file operations attempted by the monitored process,
intercept, by said software module, a function call of one of said specified function calls,
modify, by said software module, an execution of said function, to suspend said file operation attempted by said monitored process,
process a file referenced by said file operation, by applying a plurality of data security operations thereupon,
return an expected value to said monitored process with respect to said file, and
issue a notification to a user of said computer system with respect to a result of said processing.

2. The system of claim 1, wherein said set of monitored processes is predetermined by a user of said computer system with respect to each of said applications.

3. The system of claim 1, wherein said software nodule comprises a dynamic-link library (DLL) hook configured to perform said intercepting.

4. The system of claim 1, wherein said specified function call is a close for a handle.

5. The system of claim 4, wherein said computer system comprises a Windows operating system, and said specified function call NtClose.

6. The system of claim 1, wherein said file operations are one of: write, append, modify, upload, and delete.

7. The system of claim 1, wherein said processing only occurs when said file meets a plurality of criteria selected form the group consisting of: not a system file; not a hidden file; not a read-only file; has a length of more than 1 byte; does not exist in a delete queue; and has a single reference upon itself.

8. The system of claim 1, wherein said processing only occurs when said file is located in a folder that is not one of: a temporary folder, and a Program Data folder.

9. The system of claim 1, wherein said plurality of security operations are selected form the group consisting of: file approval, file blocking, file quarantining, and record of file operations.

10. A method comprising:
detecting a start of one of a set of monitored process, each associated with an application installed on a computer system,
injecting said detected monitored process of said set of monitored process with a software module configured to intercept specified functions calls by the monitored process, wherein said specified function call are associated with file operations attempted by the monitored process,
intercepting, by said software module, a function call of one of said specified function calls,
modifying, by said software module, an execution of said function, to suspend said file operation attempted by said monitored process,
processing a file referenced by said file operation, by applying a plurality of data security operations thereupon,
returning an expected value to said monitored process with respect to said file, and
issuing a notification to a user of said computer system with respect to a result of said processing.

11. The method of claim 10, wherein said set of monitored processes is predetermined by a user of said computer system with respect to each of said applications.

12. The method of claim 10, wherein said software nodule comprises a dynamic-link library (DLL) hook configured to perform said intercepting.

13. The method of claim 10, wherein said specified function call is a close for a handle.

14. The method of claim 13, wherein said computer system comprises a Windows operating system, and said specified function call NtClose.

15. The method of claim 10, wherein said file operations are one of: write, append, modify, upload, and delete.

16. The method of claim 10, wherein said processing only occurs when said file meets a plurality of criteria selected form the group consisting of: not a system file; not a hidden file; not a read-only file; has a length of more than 1 byte; does not exist in a delete queue; and has a single reference upon itself.

17. The method of claim 10, wherein said processing only occurs when said file is located in a folder that is not one of: a temporary folder, and a Program Data folder.

18. The method of claim 10, wherein said plurality of security operations are selected form the group consisting of: file approval, file blocking, file quarantining, and record of file operations.

19. A computer program product comprising a non-transitory computer-readable storage medium having program instructions embodied therewith, the program instructions executable by at least one hardware processor to:
detect a start of one of a set of monitored process, each associated with an application installed on a computer system,
inject said detected monitored process of said set of monitored process with a software module configured to intercept specified functions calls by the monitored process, wherein said specified function call are associated with file operations attempted by the monitored process,
intercept, by said software module, a function call of one of said specified function calls,
modify, by said software module, an execution of said function, to suspend said file operation attempted by said monitored process,
process a file referenced by said file operation, by applying a plurality of data security operations thereupon,
return an expected value to said monitored process with respect to said file, and
issue a notification to a user of said computer system with respect to a result of said processing.

20. The computer program product of claim 19, wherein said file operations are one of: write, append, modify, upload, and delete.
